(19) United States
(12) Patent Application Publication
(10) Pub. No.: US 2021/0146815 A1
(43) Pub. Date: May 20, 2021

(54) LINING ELEMENT

(71) Applicant: ADIENT ENGINEERING AND IP GMBH, BURSCHEID (DE)

(72) Inventors: SEBASTIAN EVELS, WUPPERTAL (DE); AHMED OUALKADI, VELBERT (DE); VEDAT NUYAN, WUPPERTAL (DE); LANDO SCHLESINGER, WERMELSKIRCHEN (DE)

(21) Appl. No.: 16/617,103

(22) PCT Filed: May 31, 2018
(86) PCT No.: PCT/EP2018/064348

§ 371 Date: Nov. 26, 2019

(30) Foreign Application Priority Data
Jun. 1, 2017 (DE) 10 2017 209 361.7
Oct. 17, 2017 (DE) 10 2017 218 540.6

(51) Int. Cl. B60N 2/68; B60N 2/64; B60N 2/90

(52) U.S. Cl. CPC B60N 2/686; B60N 2205/30; B60N 2/986; B60N 2/643

(57) ABSTRACT

A lining element for a backrest of a vehicle seat, in particular for the rear face of the back seat is provided. A number of soft lining parts, which are arranged on the front face, and two or more solid lining parts, which are arranged on the rear face and are connected to the soft lining parts, are provided. The degree of deformability of the lining elements towards the rear is preferably greater than the degree of deformability towards the front.

The invention relates to a lining element for a backrest of a vehicle seat, in particular for at least one rear face of a vehicle seat.

Lining elements for a backrest of a vehicle seat are known in the prior art, said lining elements being formed in one piece from plastics material.

It is the object of the present invention to specify an improved lining element for at least one backrest of a vehicle seat.

The object is achieved according to the invention by a lining element having the features cited in claim 1.

Advantageous embodiments of the lining element according to the invention form the subject matter of the subclaims.

A lining element is provided for a backrest of a vehicle seat, in particular for a rear face of the backrest. According to the invention, a number of soft, in particular resiliently flexible, lining parts is provided, said soft lining parts being arranged on the front face, i.e. in particular facing the seat, and a plurality of solid lining parts is provided, said solid lining parts being connected thereto on the rear face, i.e. in particular facing away from the seat.

In this case, the degree of deformability of the lining element toward the rear is preferably greater than the degree of deformability thereof toward the front, whereby additional protection for an occupant is achievable.

Since the lining element is at least partially flexible it may be adapted to a changing shape of a backrest, for example when the shape is changed as a result of a seat adjuster or when a relatively heavy occupant is seated on a seat and deforms the backrest toward the rear. The lining element according to the invention is flexible, in particular bendable in a defined manner, such that it adapts in a simple manner to a shape of the seat. In this case the flexible portions of the lining element act in the manner of a hinge, wherein the soft lining parts form a hinge and the solid lining parts form a hinge member; in this case the soft lining parts are resiliently flexible in the manner of a textile or in the manner of an elastomer and the solid lining parts are barely stretchable and barely bendable.

Thus a flexibility of the lining element which is structurable in a defined manner is advantageous. The invention permits novel options for designing a rear face of the seat by configuring soft and solid regions which may be formed by the number of soft lining parts and the plurality of solid lining parts connected thereto.

By means of the structurable and thus definable flexibility of the lining element according to the invention the seating comfort of a person seated on the seat is further improved. The lining element according to the invention is bendable toward the rear such that it increasingly deforms in a convex manner on the rear face. An at least partial deformation of the lining element toward the rear is thus possible. As a result, the person who is seated on the seat is able to sink into the backrest, whereby for example in the event of a collision with the relevant vehicle, the risk of injury to a person, in particular relating to a whiplash injury, is at least reduced.

In this case, depending on the design, an at least partial deformation of the lining element toward the front, for example by an item of luggage striking against the backrest from the rear in the event of an accident or by a knee of a rear passenger, may also be hindered or prevented. This is effected by each of the solid lining parts against which the respective item of luggage or the respective knee strikes. In this case, the plurality of solid lining parts is fastened to the plurality of soft lining parts such that the lining element is not deformable or at least barely deformable toward the front. This is made possible by the cooperation of the solid lining parts with the soft lining parts and optionally by a stop element in the backrest and/or optionally by an integrated fixing element.

Preferably, by means of the invention a separate supporting spring system, which in the prior art is arranged spaced apart from conventional lining elements in order to avoid noise or detachment, is not necessary. Thus in addition to saving constructional space it is also possible to substitute a separate supporting spring system.

An embodiment of the lining element provides that the number of soft lining parts is formed form silicone, from a woven fabric, from thermoplastic elastomer, from polyurethane (TPU) or from a combination thereof. As a result, the lining element is able to be produced in a simple and cost-effective manner, is long-lasting and thus useable over a long period of time.

A further embodiment of the lining element provides that the plurality of solid lining parts is formed from a hard material, for example from thermoplastic material. As a result, the lining element is able to be produced in a simple and cost-effective manner, is highly durable on the rear face, is long-lasting and thus useable over a long period of time.

A further embodiment of the invention provides that the lining element is a two-component part. As a result, the lining element is particularly highly durable.

An important embodiment of the lining element provides that on a surface on the rear face of the lining element in each case the solid lining parts have a small spacing from the respectively adjacent solid lining part, relative to a size of a solid lining part. In other words, a gap between the solid lining parts on the surface on the rear face is significantly smaller than a size of the solid lining part, for example less than 15% or 10% or 7.5% or 5% or 2% of the size of the solid lining part. In this case a gap may run substantially horizontally, between two solid lining parts which are arranged so as to be superimposed, or vertically, i.e. between two solid lining parts which are arranged adjacent to one another.

Alternatively, on the surface on the rear face the size of a gap between two adjacent solid lining parts, at least on the surface on the rear face, may also be zero, i.e. two adjacent solid lining parts may also come into contact with one another at least on the surface on the rear face. As a result, a mobility of the aforementioned hinge is definable, i.e. at least limitable in a defined manner in a hinge pivoting direction.

A further embodiment of the lining element provides that the solid lining parts taper toward the front, i.e. in the direction of the backrest. As a result, a hinge action between adjacent solid lining parts is definable in a particularly effective manner.

A further embodiment of the lining element provides that a number of soft intermediate elements is arranged between respectively adjacent solid lining parts. As a result, a hinge action between adjacent solid lining parts is also definable in a particularly effective manner.

A further embodiment of the lining element provides that two respectively adjacent solid lining parts are in contact with one another or at least partially overlap. As a result, not only is a hinge action between adjacent solid lining parts definable in a particularly effective manner but a rear view of the lining element may be designed in a manner which is aesthetically very attractive.

A further important embodiment of the lining element provides an additional device which counteracts a deformation toward the front and which comprises a number of traction elements which are arranged on the front face and which, for example, run substantially vertically, for example wires, wherein a traction element is fastened in each case by means of fixing elements on the front face, i.e. facing the seat, to the solid lining parts. As a result, it is also possible to counteract a deformation toward the front in a very effective manner. In this case the additional device acts as a reinforcement which, however, is activated only with a partial deformation toward the front, but with a partial deformation toward the rear it flexes, i.e. it is deactivated. In the case of the action of a force from the rear toward the front against the lining element, therefore, the traction elements tighten or harden so that a deformation toward the front is additionally counteracted. As the additional device is arranged on the front face, it is not visible when the lining element is mounted.

It is also possible that a mat which is formed from wires is provided as an additional device, a protection of the soft lining parts and/or a limit to a deformation of the lining element against a deformation oriented toward the front being possible thereby.

A further embodiment of the lining element provides at least one flexible side region in which a number of solid lining parts is arranged on a side remote from the seat of a soft lining part facing the seat. By means of the flexible side region the function of side airbags in the backrest is permitted and/or simplified. A flexible side region may be folded away when a side airbag of the backrest is deployed, wherein a region, for example a strip, of the soft lining part functions as a hinge. As the lining element, in particular the lining element with the number of flexible side regions, is at least partially flexible it may be adapted to a changing shape of a backrest, for example when the shape changes as a result of a seat adjuster which, for example, comprises adjustable side cushions of the backrest.

Exemplary embodiments of the invention are described in more detail with reference to the drawings, in which:

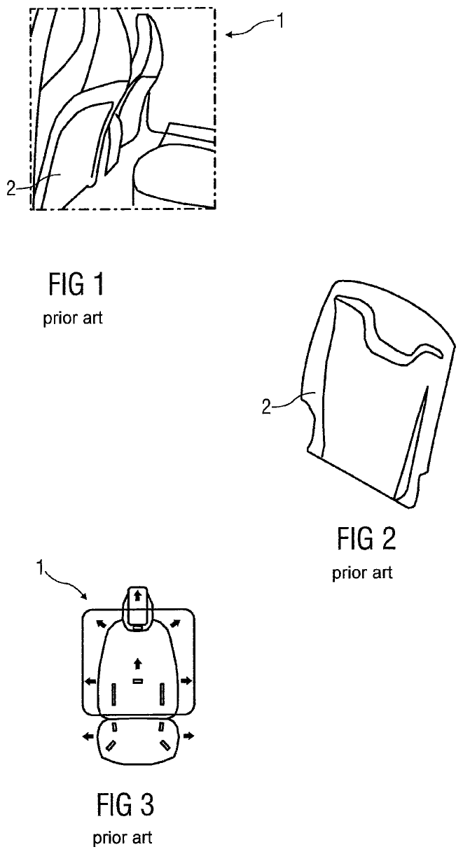

FIG. 1 shows a backrest of a vehicle seat according to the prior art,

FIG. 2 shows a lining element of this backrest of a vehicle seat according to the prior art,

FIG. 3 shows options for adjusting a vehicle seat according to the prior art,

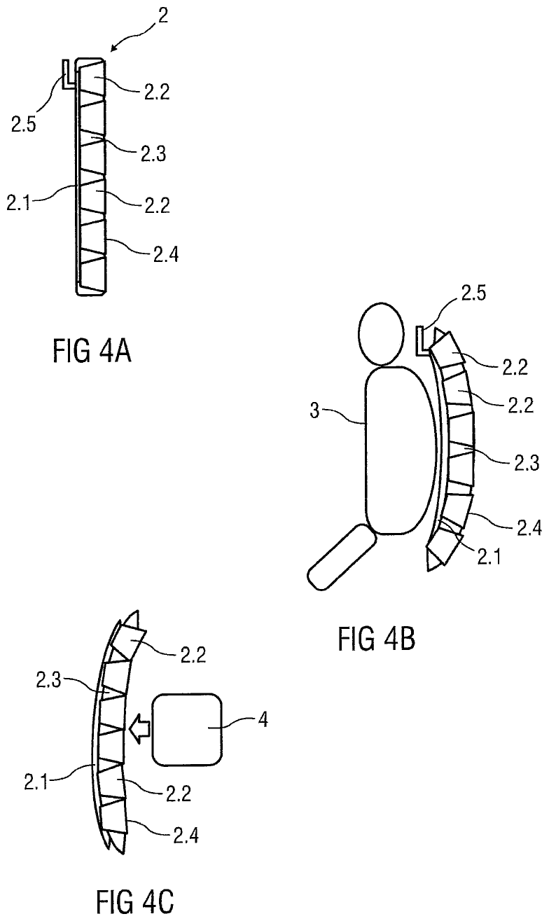

FIG. 4a shows a first embodiment of a lining element according to the invention in a schematic sectional view,

FIG. 4b shows an associated schematic sectional view with a deformation toward the rear,

FIG. 4c shows an associated schematic sectional view with a deformation toward the front,

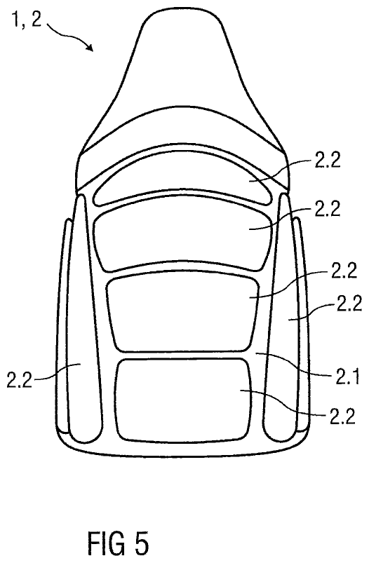

FIG. 5 shows a second embodiment of a lining element according to the invention in a view from the rear,

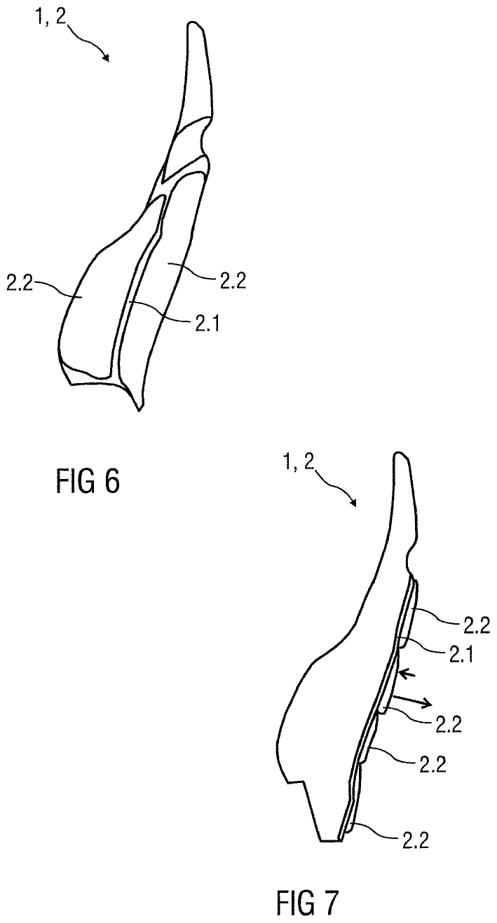

FIG. 6 shows the second embodiment of a lining element according to the invention in a side view,

FIG. 7 shows a third embodiment of a lining element according to the invention in a schematic sectional view,

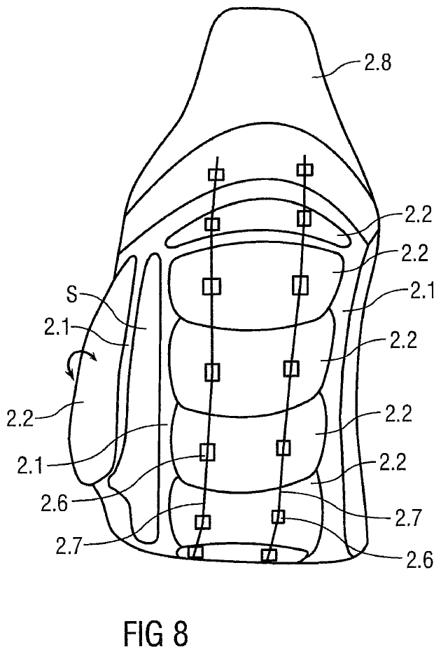

FIG. 8 shows a fourth embodiment of a lining element according to the invention in a schematic view from the rear,

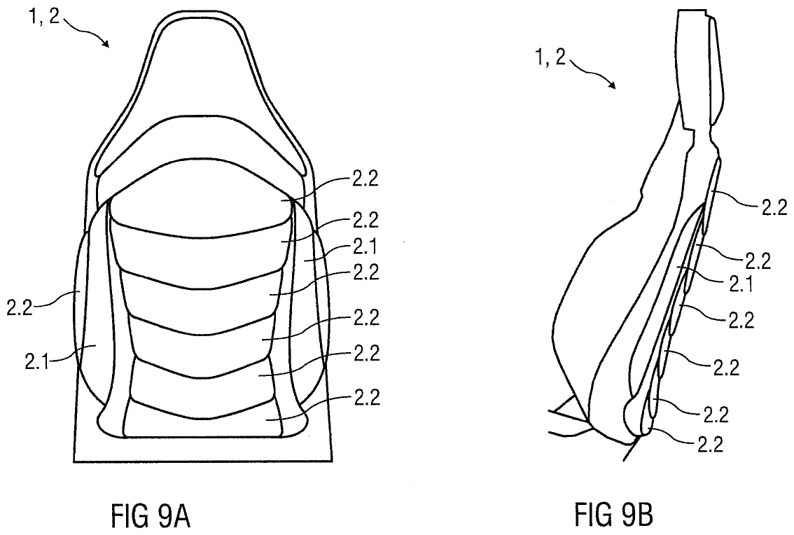

FIG. 9a shows the fourth embodiment of a lining element according to the invention in a view from the rear,

FIG. 9b shows an associated sectional view,

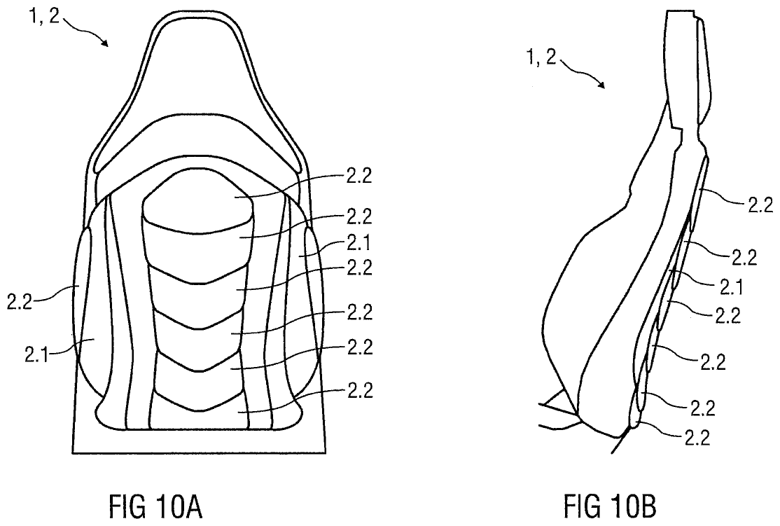

FIG. 10a shows a fifth embodiment of a lining element according to the invention in a view from the rear,

FIG. 10b shows an associated sectional view,

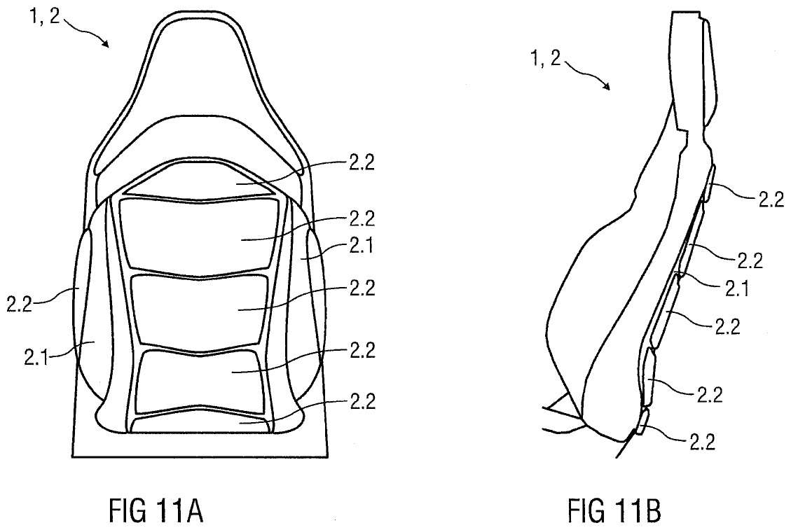

FIG. 11a shows a sixth embodiment of a lining element according to the invention in a view from the rear,

FIG. 11b shows an associated sectional view,

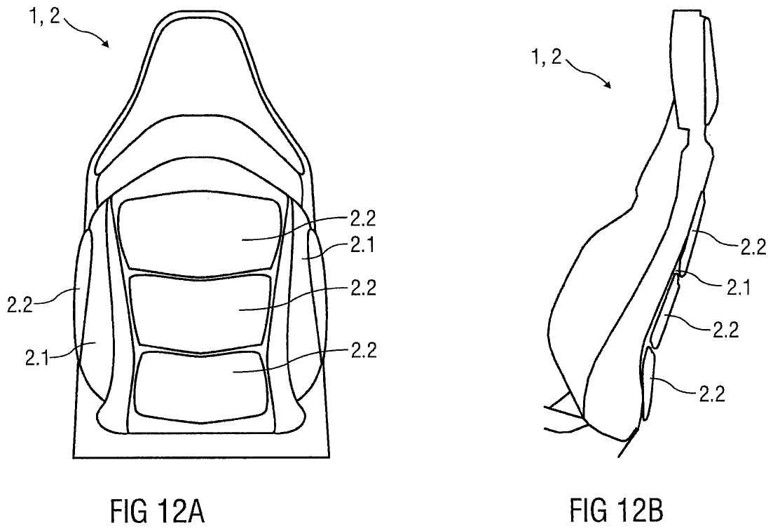

FIG. 12a shows a seventh embodiment of a lining element according to the invention in a view from the rear,

FIG. 12b shows an associated sectional view,

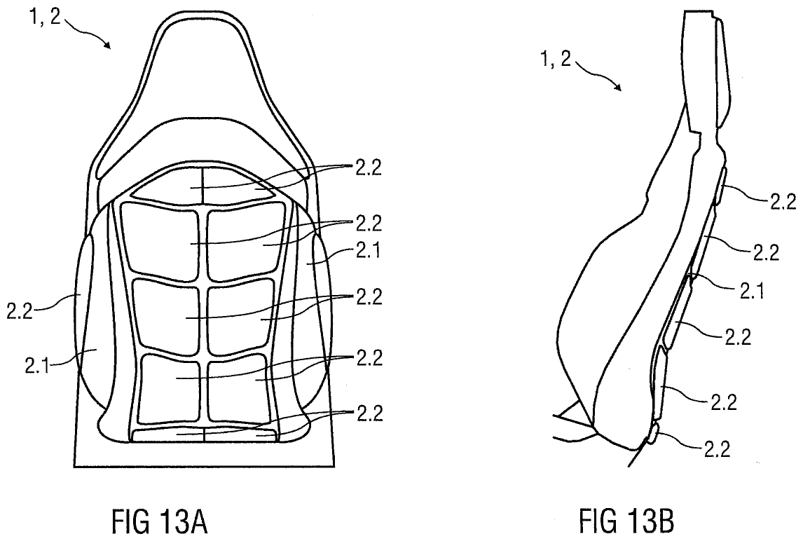

FIG. 13a shows an eighth embodiment of a lining element according to the invention in a view from the rear,

FIG. 13b shows an associated sectional view,

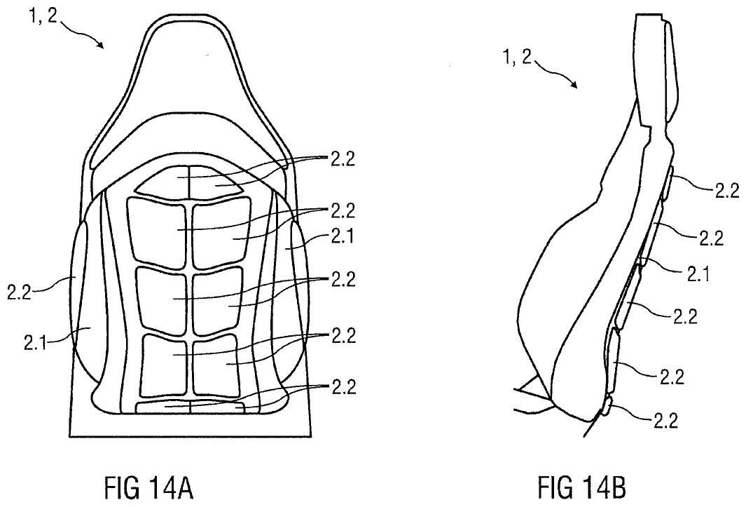

FIG. 14a shows a ninth embodiment of a lining element according to the invention in a view from the rear and

FIG. 14b shows an associated sectional view.

Parts which correspond to one another are provided in all of the figures with the same reference numerals.

FIG. 1 shows a backrest 1 of a vehicle seat according to the prior art, a lining element 2 according to the prior art being arranged on the rear face thereof.

This lining element 2 is shown separately in FIG. 2 and serves for covering the backrest 1 on the rear face.

FIG. 3 schematically shows options for adjusting a vehicle seat according to the prior art, in particular options for adjusting a backrest 1. In the backrest 1, for example, the height of a head restraint, the width in the shoulder region and the width in the lumbar region are adjustable.

FIG. 4a shows a first embodiment of a lining element according to the invention 2 in a schematic sectional view. The lining element 2 comprises a soft lining part 2.1 which is preferably formed from silicone and/or from a woven fabric, a plurality of, preferably six, solid lining parts 2.2 which preferably consist of thermoplastic material being fastened to the rear face thereof. Optional, soft intermediate elements 2.3 are arranged in each case between adjacent solid lining parts 2.2. On a surface 2.4 on the rear face of the lining element 2, the solid lining parts 2.2 which taper toward the front in each case have a small spacing from the respectively adjacent solid lining part 2.2. In the upper region of the lining element 2 an optional fastening element 2.5 is shown schematically, the lining element 2 being fastenable thereby to a backrest 1, not shown.

FIG. 4b shows an associated schematic sectional view with a deformation toward the rear which may occur by a person 3 sitting down in the seat or pushing the seat toward the rear. In this case, the lining element 2 is deformed in a convex manner toward the rear. This deformation is possible in a simple manner by the flat, soft lining part 2.1 bending, without having to be stretched as a whole. The spacings on the rear face between the solid lining parts 2.2 are enlarged at the same time. As a result, the comfort of the person is improved.

FIG. 4c shows an associated schematic sectional view with a deformation toward the front which may occur by an item of luggage 4 being pushed toward the front against the seat, for example in the event of an accident. In this case, the lining element 2 does not deform in a concave manner, or at any rate only slightly, toward the rear. It is possible to limit this deformation in a simple manner since the flat, soft lining part 2.1 is bendable. The spacings on the rear face between the solid lining parts 2.2 are initially reduced at the same time; as soon as the solid lining parts 2.2 come into contact with one another, a further deformation in the specified direction is substantially prevented, whereby the safety of the person, not shown here, is improved.

FIG. 5 shows a second embodiment of a lining element 2 according to the invention in a view from the rear. The lining element 2 has four plate-shaped solid lining parts 2.2 which are arranged superimposed and solid lining parts 2.2 which in each case are arranged laterally. All of the lining parts 2.2 are arranged on a common planar, soft lining part 2.1.

FIG. 6 shows the second embodiment of a lining element according to the invention 2 in a side view, wherein two solid lining parts 2.2 are arranged on one side adjacent to one another, wherein a strip of the soft lining part 2.1 is configured between the two solid lining parts 2.2. As a result, when a side airbag arranged in the backrest 1 is deployed, the solid lining part 2.2 shown to the left is able to fold away to the side so that the airbag may be deployed without the risk of a component of the lining element 2 splintering. In this case, the strip of the soft lining part 2.1 which is configured between the two solid lining parts 2.2 functions as a hinge.

FIG. 7 shows a third embodiment of a lining element 2 according to the invention in a schematic sectional view. The lining element 2 comprises four plate-shaped solid lining parts 2.2 on the rear face, said solid lining parts being arranged in the soft lining part 2.1. The lining element 2 permits a deformation toward the rear and counteracts a deformation toward the front.

FIG. 8 shows a fourth embodiment of a lining element 2 according to the invention in a schematic view from the rear. This embodiment corresponds substantially to the embodiment shown in FIG. 5 but has an optional additional device which also counteracts a deformation toward the front. This device is arranged on the front face on the lining element 2, i.e. is not visible when the lining element 2 is mounted, and comprises two substantially vertically arranged optional wires as deformation-limiting traction elements 2.7. Each traction element 2.7 is fastened in each case by means of five fixing elements 2.6 to each of the five plate-shaped solid lining parts 2.2 and preferably attached both at the top and at the bottom to a frame element of the lining part. In the event of the action of a force from the rear toward the front against the lining element 2, the traction elements 2.7 tighten and are activated so that a deformation toward the front is additionally counteracted. It is alternatively possible that the traction element 2.7 are not configured as wires but as elements which stiffen when deformed toward the front.

A solid lining part 2.2, and spaced apart therefrom a side lining part S, are arranged adjacent to one another on at least the left-hand side, wherein a strip of the soft lining part 2.1 is configured between this solid lining part 2.2 and the side lining part S. As a result, when a side airbag arranged in the backrest 1 is deployed, the solid lining part 2.2 shown to the left may be folded away to the side so that the airbag may be deployed without the risk of a component of the lining element 2 splintering. In this case, the strip of the soft lining part 2.1 which is configured between the two solid lining parts 2.2 functions as a hinge. The possibility of folding away to the side is shown by an arrow.

According to a first alternative, the side lining part S is also a solid lining part 2.2, i.e. a component of the lining element 2. According to a second alternative, the side lining part S is a component of a fixed frame part of the seat, i.e. is not a component of the lining element 2.

FIGS. 9a and 9b show the fourth embodiment of the lining element 2 according to the invention. The lining element 2 comprises six relatively wide plate-shaped solid lining parts 2.2, with a rear view in an overlapping arrangement, wherein the solid lining parts 2.2 partially overlap. All of the solid lining parts 2.2 are incorporated in the common soft lining part 2.1. The overlapping may be configured in a stepped manner such that adjacent solid lining parts 2.2 are in contact with one another when deformed toward the front, so that a hinge action is limited, as described above.

FIGS. 10a and 10b show a fifth embodiment of a lining element 2 according to the invention. The lining element 2 comprises six relatively narrow plate-shaped solid lining parts 2.2 which are arranged so as to be superimposed, with a rear view in an overlapping arrangement, wherein the solid lining parts 2.2 partially overlap. All of the solid lining parts 2.2 are incorporated in the common soft lining part 2.1, wherein the overlap is visible from the rear.

FIGS. 11a and 11b show a sixth embodiment of a lining element 2 according to the invention. The lining element 2 comprises five relatively wide plate-shaped solid lining parts 2.2 which are arranged so as to be superimposed, with a rear view in a plate-like arrangement, wherein the solid lining parts 2.2 partially overlap, at least to a small extent. All of the solid lining parts 2.2 are incorporated in the common soft lining part 2.1, wherein the overlap is not visible from the rear.

FIGS. 12a and 12b show a seventh embodiment of a lining element 2 according to the invention. The lining element 2 comprises three relatively wide plate-shaped solid lining parts 2.2 which are arranged so as to be superimposed, with a rear view in a plate-like arrangement, wherein the solid lining parts 2.2 partially overlap, at least to a small extent. All of the solid lining parts 2.2 are incorporated in the common soft lining part 2.1, wherein the overlap is not visible from the rear.

FIGS. 13a and 13b show an eighth embodiment of a lining element 2 according to the invention. The lining element 2 comprises, amongst other things, six plate-shaped solid lining parts 2.2 which are arranged in the manner of a matrix, with a rear view in a plate-like arrangement, wherein the solid lining parts 2.2 which are arranged so as to be superimposed partially overlap, at least to a small extent. All of the solid lining parts 2.2 are incorporated in the common soft lining part 2.1, wherein the overlap is not visible from the rear.

FIGS. 14a and 14b show a ninth embodiment of a lining element 2 according to the invention. The lining element 2 comprises, amongst other things, six plate-shaped solid lining parts 2.2 which are arranged in the manner of a matrix, with a rear view in a plate-like arrangement, wherein the solid lining parts 2.2 which are arranged so as to be superimposed partially overlap, at least to a small extent. All of the solid lining parts 2.2 are incorporated in the common soft lining part 2.1, wherein the overlap is not visible from the rear.

### LIST OF REFERENCE NUMERALS

1 Backrest
2 Lining element
2.1 Soft cladding part
2.2 Solid cladding part
2.3 Soft intermediate element
2.4 Surface on the rear face
2.5 Fastening element
2.6 Fixing element
2.7 Traction element
3 Person
4 Item of luggage
S Side cladding part

1-11. (canceled)

12. A lining element for a backrest of a vehicle seat, in particular for a rear face of the backrest, comprising a number of soft lining parts which are arranged on the front face and a plurality of solid lining parts which are connected thereto on the rear face.

13. The lining element as claimed in claim 12, wherein the number of soft lining parts is formed from silicone, from a woven fabric, from thermoplastic elastomer or a combination thereof and in that the degree of deformability of the lining element toward the rear is greater than the degree of deformability thereof toward the front.

14. The lining element as claimed in claim 13, wherein the plurality of solid lining parts is formed from a hard material, including thermoplastic material.

15. The lining element as claimed in claim 12, wherein the lining element is a two-component part.

16. The lining element as claimed in claim 12, wherein on a surface on the rear face of the lining element in each case the solid lining parts have a small spacing from the respectively adjacent solid lining part relative to a size of a solid lining part.

17. The lining element as claimed in claim 12, wherein the solid lining parts taper toward the front.

18. The lining element as claimed in claim 12, wherein soft intermediate elements are arranged between respectively adjacent solid lining parts.

19. The lining element as claimed in claim 12, wherein respectively adjacent solid lining parts are in contact with one another or at least partially overlap.

20. The lining element as claimed in claim 12, further comprising an additional device which counteracts a deformation toward the front.

21. The lining element as claimed in claim 20, wherein the device comprises a number of wires which are arranged on the front face as traction elements, wherein a traction element is fastened in each case via fixing elements on the front face to the solid lining parts.

22. The lining element as claimed in claim 12, further comprising a flexible side region in which a number of solid lining parts is arranged on a side remote from the seat of a soft lining part facing the seat.
